(19) United States
(12) Patent Application Publication
(10) Pub. No.: US 2009/0101415 A1
(43) Pub. Date: Apr. 23, 2009

(54) Apparatus, method, computer program and user interface for enabling user input

(75) Inventors: Morten Rolighed Christensen, Lyngby (DK); Claus Jorgensen, Frederiksberg (DK); Vooi Kia Tan, Copenhagen K (DK); Mikkel Morup, Drager (DK); Herman Scherling, Kokkedal (DK); Thomas Horup Pedersen, Frederiksberg C (DK); Nikolaj Heiberg Bestle, Copenhagen O (DK)

Correspondence Address: HARRINGTON & SMITH, PC, 4 RESEARCH DRIVE, Suite 202, SHELTON, CT, 06484-6212, US

(73) Assignee: Nokia Corporation

(21) Appl. No.: 11/975,614

(22) Filed: Oct. 19, 2007

(51) Int. Cl. G06F 3/041

(52) U.S. Cl. 178/18.01

(57) ABSTRACT

An apparatus including a touch sensitive input device configured to provide an output dependent upon an actuated area; and a processor configured to receive inputs from the touch sensitive input device; wherein the processor is configured to detect a change in orientation of an actuated area and, in response to the detection of the change in orientation, perform a function.

### FIELD OF THE INVENTION

Embodiments of the present invention relate to an apparatus, method, computer program and user interface for enabling user input. In particular, they relate to an apparatus, method, computer program and user interface for enabling user input using a touch sensitive input device.

### BACKGROUND TO THE INVENTION

Electronic apparatus having touch sensitive input devices such as touch sensitive displays or touchpads for enabling a user to input information into the apparatus and to control the apparatus are well known. It would be advantageous to configure such touch sensitive input devices to be simple and intuitive for a user to use whilst enabling a wide range of controls and commands to be made.

### BRIEF DESCRIPTION OF THE INVENTION

According to one embodiment of the invention there is provided an apparatus comprising: a touch sensitive input device configured to provide an output dependent upon an actuated area; and a processor configured to receive inputs from the touch sensitive input device; wherein the processor is configured to detect a change in orientation of an actuated area and, in response to the detection of the change in orientation, perform a function.

This provides the advantage that a user of the apparatus can make an input by rotating a user input device such as their finger or a stylus on the touch sensitive input device. Such inputs may be used for controlling a variable parameter of the apparatus. For example the angle though which the user input device is rotated could indicate the amount by which a user wishes to increase or decrease a variable parameter.

Such inputs may also be useful for selecting options in a menu. For example, a user may be able to select an option from a list of options presented to a user by rotating the user input device on the touch sensitive input device in the area corresponding to the option which they wish to select.

According to another embodiment of the invention there is provided a method comprising; receiving a first input from a touch sensitive input device when an area of the touch sensitive input device in a first orientation is actuated; receiving a second input from the touch sensitive input device when an area of the touch sensitive input device in a second orientation is actuated; detecting, using the first input and the second input, change in the orientation; and performing, in response to the detection of the change in orientation, a function.

According to another embodiment of the invention there is provided a computer program comprising program instructions for controlling an apparatus, the apparatus comprising, a touch sensitive input device, the program instructions providing, when loaded into a processor: means for receiving a first input from the touch sensitive input device when an area of the touch sensitive input device in a first orientation is actuated; means for receiving a second input from the touch sensitive input device when an area of the touch sensitive input device in a second orientation is actuated; means for detecting, using the first input and the second input, change in the orientation; and means for performing, in response to the detection of change in the orientation, a function.

According to another embodiment of the invention there is provided a user interface comprising: a touch sensitive input device configured to provide an output dependent upon an actuated area such that the outputs provided by the touch sensitive input device enable a processor to detect change in orientation of an actuated area: and wherein in response to the detection of the change in orientation, a function is performed.

The apparatus may be for wireless communication.

### BRIEF DESCRIPTION OF THE DRAWINGS

For a better understanding of the present invention reference will now be made by way of example only to the accompanying drawings in which:

FIG. 1 schematically illustrates an electronic apparatus;

FIG. 2 illustrates a flow chart showing method blocks of an embodiment of the present invention;

FIGS. 3A to 3C illustrate a touch sensitive input device according to an embodiment of the present invention;

FIG. 4 illustrates a first graphical user interface according to an embodiment the present invention;

FIG. 5 illustrates a second graphical user interface according to an embodiment the present invention; and

FIGS. 6A to 6B illustrate a third graphical user interface according to an embodiment the present invention.

### DETAILED DESCRIPTION OF EMBODIMENTS OF THE INVENTION

The Figures illustrate an apparatus comprising: a touch sensitive input device 11 configured to provide an output dependent upon an actuated area; and a processor 3 configured to receive inputs from the touch sensitive input device 11; wherein the processor 3 is configured to detect 25 a change in orientation of an actuated area and, in response to the detection 25 of the change in orientation, perform 27 a function.

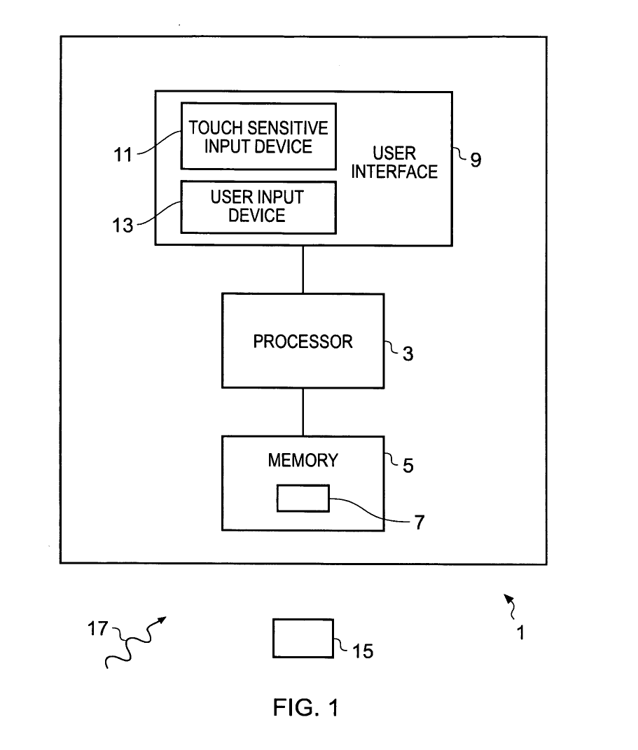

FIG. 1 schematically illustrates an electronic apparatus 1. Only the features referred to in the following description are illustrated. It should, however, be understood that the apparatus 1 may comprise additional features that are not illustrated. The electronic apparatus 1 may be, for example, a mobile cellular telephone, a personal computer, a personal digital assistant, a personal music player or any other electronic apparatus that comprises a touch sensitive input device. The electronic apparatus 1 may be a handheld apparatus which can be carried in a user's hand, handbag or jacket pocket, for example.

The illustrated electronic apparatus 1 comprises: a user interface 9, a memory 5 and a processor 3. The processor 3 is connected to receive input commands from the user interface 9 and to provide output commands to the user interface 9. The processor 3 may be configured to monitor, at predetermined intervals, for input commands from the user interface 9. The processor 3 is also connected to write to and read from the memory 5.

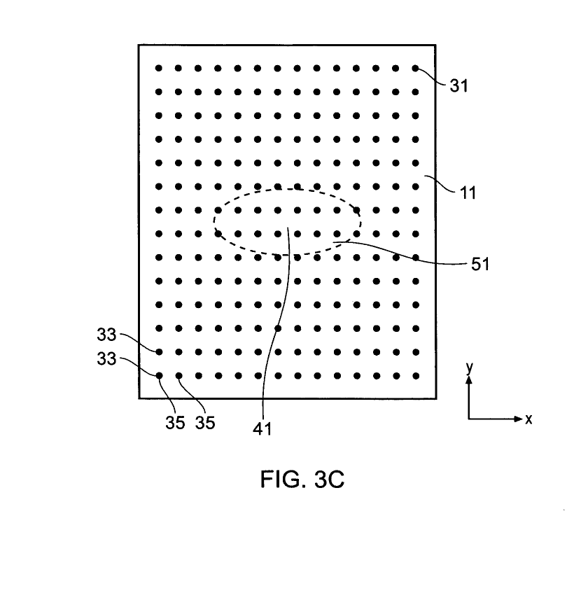

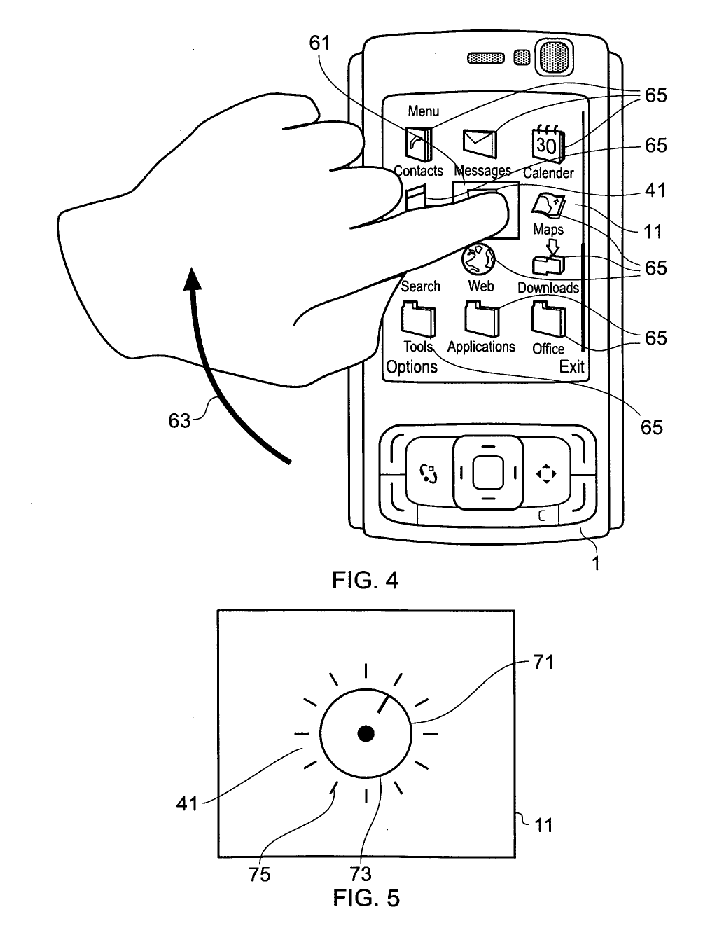

The user interface 9 comprises a touch sensitive input device 11. The touch sensitive input device 11 may be, for example, a touch sensitive display which is configured to present a graphical user interface to a user. Examples of graphical user interfaces according to embodiments of the invention are illustrated in FIGS. 4 and 5. Alternatively the touch sensitive input device 11 may be a touch pad or any other user input device configured to detect a user contacting the surface of the device.

The touch sensitive input device 11 is configured to enable a user to input information into the apparatus 1 and to access the functions of the apparatus 1. The apparatus 1 may also comprise a further user input device 13 such as, any one or more of, a key, keypad, a joystick or roller or any other suitable user input device.

The touch sensitive input device 11 has a sensitivity which enables it to provide outputs which are dependent on the orientation of an actuated area and thereby enables the touch sensitive input device 11 to differentiate been an actuated area in a first orientation and an actuated area in a second orientation. For example, the sensitivity of the touch sensitive input device 11 may enable the touch sensitive input device 11 to provide a first output when a user touches the touch sensitive input device 11 in a first orientation at a first position and second output when the user touches the touch sensitive input device 11 in a second orientation at the first position. The outputs of the touch sensitive input device 11 are provided to the processor 3 for processing.

The touch sensitive input device 11 may have sensitivity such that the output provided by the touch sensitive input device 11 is dependent on the orientation of the actuated area for any region of the touch sensitive input device 11. In other embodiments the touch sensitive input device 11 may have sensitivity such that the output provided by the touch sensitive input device 11 is dependent on the orientation of the actuated area for only particular portions of the touch sensitive input device 11.

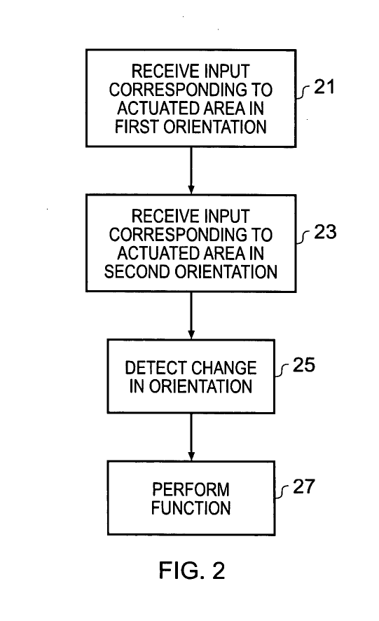

The memory 5 stores computer program instructions 7, which when loaded into the processor 3, enable the processor 3 to control the operation of the apparatus 1 as described below. The computer program instructions 7 provide the logic and routines that enables the electronic apparatus 1 to perform the method illustrated in FIG. 2.

The computer program instructions 7 may arrive at the electronic apparatus 1 via an electromagnetic carrier signal or be copied from a physical entity such as a computer program product, a memory device or a record medium such as a CD-ROM or DVD.

A method of controlling the device 1, according to the present invention, is illustrated schematically in FIG. 2.

At block 21 a user has actuated an area 43 of the touch sensitive input device 11. The actuated area 43 is in a first orientation. The actuated area 43 is defined by the area of contiguous sensors which are contemporaneously actuated by the user of the apparatus 1. A user may actuate the sensors of the touch sensitive input device 11 by contacting the surface of the touch sensitive input device 11 either by touching it with a user input device or by bringing a user input device close to the surface of the touch sensitive input device 11. The user input device may be, for example, a user's finger or a stylus.

The output received is provided by the touch sensitive input device 11 and is dependent upon the actuated area 43. The output provided may also be dependent on other factors including, for example, the mode of operation of the apparatus or the region of the touch sensitive input device 11 in which the actuated area is located.

At block 23 the user has rotated the user input device so that the actuated area 51 is now in a second orientation.

When the user rotates the user input device, the user input device may remain in contact with the touch sensitive input device 11. In some embodiments the user input device may also remain in the same position 41 on the surface of the touch sensitive input device 11 so that although the user input device has been rotated there is no or substantially no translational movement of the user input device across the surface of the touch sensitive input device 11. For example, when the user rotates the user input device the user input device may remain positioned over an icon or within a demarcated area on the touch sensitive input device 11.

When the user input device is in the second orientation the touch sensitive input device 11 provides 23 a second output to the processor 3. The second output is also dependent upon the orientation of the actuated area of the touch sensitive input device 11. The second output may also be dependent upon other factors including, for example, the mode of operation of the apparatus or the region of the touch sensitive input device 11 in which the actuated area is located.

At block 27 the processor 3 uses the first and second inputs which have been received from the touch sensitive input device 11 to determine that there has been change in orientation. In response to the determination of change in the orientation the processor 3 will, at block 29, control the apparatus 1 to perform a function.

The function performed at block 29 may depend upon the region of the touch sensitive input device 11 in which the actuated area is located. The function may also depend upon the magnitude of the change in orientation, that is, the number of degrees through which the actuated area has been rotated. The function may also depend upon whether the change in orientation occurs in a clockwise direction or a counter-clockwise direction. Where the apparatus has a plurality of modes of operation the function performed may depend on the mode of operation of the apparatus 1.

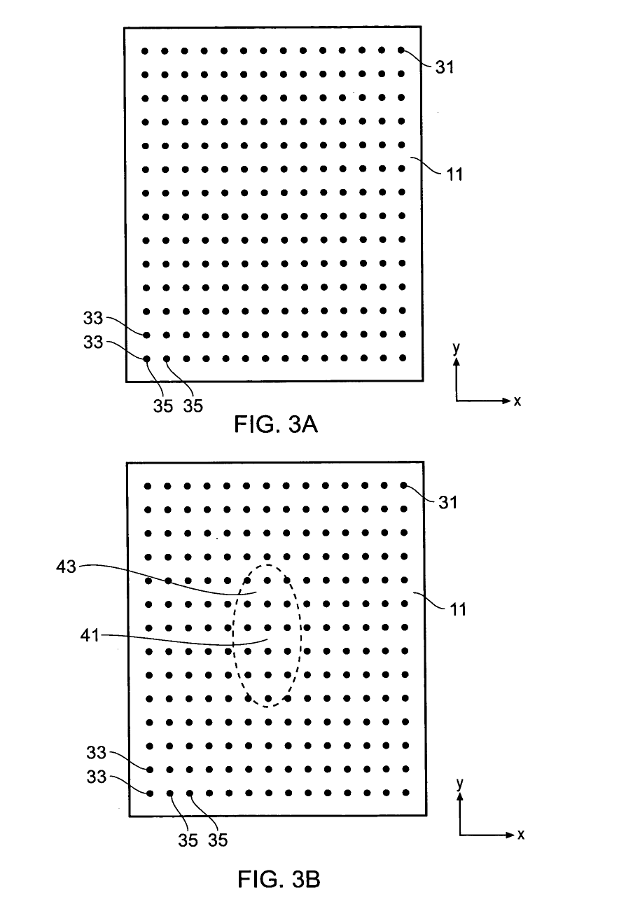

FIGS. 3A to 3C schematically illustrate a touch sensitive input device 11 according to an embodiment of the invention.

FIG. 3A illustrates a touch sensitive display 11 comprising a plurality of sensors 31. In the illustrated embodiment the plurality of sensors 31 are arranged in a two dimensional array comprising rows 33 of sensors 31 extending in a first direction and columns 35 of sensors 31 extending a second direction perpendicular to the first direction. In the particular embodiment illustrated the rows 33 of sensors 31 extend parallel to a horizontal x axis while the columns 35 of sensors 31 extend in a direction parallel to a vertical y axis. In the illustrated embodiment the touch sensitive input device 11 is rectangular and the rows 31 and columns 35 of sensors 31 are parallel with the edges of the touch sensitive input device 11. It is to be appreciated that in other embodiments the touch sensitive input device 11 may be any other shape.

The sensors 31 may be arranged so that there is an equal spacing between each sensor 31 in each row 33 and also between each sensor 31 in each column 35. The spacing between the sensors 31 in the rows 33 may be the same as the spacing between the sensors 31 in the columns 35.

The sensors 31 may be, for example, capacitive sensors. Each of the capacitive sensors may store a controlled electric charge. When a finger contacts the touch sensitive input device 11 with a user input device such as a stylus or their finger this changes the electric charge stored in the sensor because of the inherent electrical capacitance of the user input device. This change in the electrical charge stored produces an output which can be provided to the processor 3. A user may contact the touch sensitive input device 11 either by touching it with a user input device or by bringing a user input device close to the surface of the touch sensitive input device 11.

The sensors 31 are indicated by dots in FIGS. 3A to 3C for clarity. In an actual embodiment of the invention the sensors 31 may not be visible through the touch sensitive input device 11.

In FIG. 3B a user is touching the touch sensitive input device 11 in a first position 41 in a first orientation. In the embodiment illustrated in FIG. 3B the user is using a finger to contact the touch sensitive input device 11, it is to be appreciated that the user could use any other suitable user input device. The dashed lines indicate the actuated area 43 of the touch sensitive input device 11. The actuated area 43 is the area of contiguous sensors which are contemporaneously actuated. The actuated area 43 is approximately an ellipse. In FIG. 3B the actuated area 43 is orientated so that the major axis of the ellipse is substantially parallel with the columns 35 of sensors 31 extending parallel to the y axis and the minor axis of the ellipse is substantially parallel with the rows 33 of sensors 31 extending parallel to the x axis.

The sensors 31 positioned underneath the actuated area 43 are responsive to the change in capacitance caused by the user input device contacting the touch sensitive input device 11 to provide a first output. The output provided by the touch sensitive input device 11 is therefore indicative of the sensors 31 that have been actuated and thereby indicative of the location of the actuated area on the touch sensitive input device 11 and also the orientation of the actuated area.

In FIG. 3C the user has rotated their finger on the touch sensitive input device 11 through an angle of 90 degrees clockwise so that the actuated area 51 is now in a second orientation. In the embodiment illustrated in FIG. 3C the finger has remained in the first position 41 on the touch sensitive input device 11 so that area 51 is now actuated. Actuated area 51 is substantially the same shape as actuated area 43 because it is the same finger touching the touch sensitive input device 11.

In the second orientation the actuated area 51 is orientated so that the major axis of the elliptical area 51 is substantially parallel with the row 33 of sensors 31 extending parallel to the x axis and the minor axis of the ellipse is substantially parallel with the columns 35 of sensors 31 extending parallel to the y axis.

The sensors 31 positioned underneath the actuated area 51 touched by the finger are responsive to the change in capacitance caused by the finger to provide a second output indicative of the location of the actuated area on the touch sensitive input device 11 and also the orientation of the actuated area on the touch sensitive input device 11.

When the processor 3 receives the second output it will compare this with the first output and from that comparison determine that there has been a change in orientation. The processor 3 may also determine that the actuated area is in substantially the same position by comparing the center of the first actuated area 43 the centre of the second actuated area 51. Alternatively the processor 3 may determine that the finger is in the same position by determining that the two actuated areas 43, 51 overlap with a demarcated area on the touch sensitive input device 11.

The processor 3 may be able to detect change in the orientation of the finger by comparing the number of sensors 31 actuated in the x direction with the number of sensors 31 actuated in the y direction for each of the inputs it receives from the touch sensitive input device 11.

The processor 3 may also be configured to determine the magnitude of the change in orientation that is the number of degrees through which the actuated area has been rotated. This may be achieved by comparing the original orientation with the final orientation. For example the processor 3 may be configured to compare the number of sensors 31 actuated in the x direction with the number of sensors 31 actuated in the y direction for the first output and the second output provided by the touch sensitive display 11.

The processor 3 may also be configured to determine in which direction the change in orientation has occurred, that is whether the actuated area is rotated in a clockwise direction or a counter-clockwise direction. This may be achieved by receiving a plurality of inputs within a predetermined time as the user rotates the user input device and comparing the plurality of inputs. For example, in the embodiment illustrated in FIGS. 3B and 3C the user has rotated their finger 90 degrees in a clockwise direction. However the orientation of FIG. 3C could have been achieved by rotating the finger 270 degrees counter-clockwise. The processor 3 may be configured to differentiate between the two possible rotations by determining the time that elapses between the two inputs or by detecting additional inputs.

It is to be appreciated that although the actuated area has been rotated through 90 degrees in the embodiment illustrated in FIGS. 3B and 3C the touch sensitive display 11 may have a sensitivity which enables much smaller changes in orientation to be determined.

FIG. 4 illustrates an example of a graphical user interface which is presented on a display according to an embodiment of the invention. The display may be a touch sensitive display. In this particular embodiment the apparatus 1 is a wireless communications device. In other embodiments the apparatus 1 could be, for example, a personal computer, a personal digital assistant or a personal music player.

In the illustrated embodiment the graphical user interface comprises a number of menu options which are presented as icons 65 on the touch sensitive display 11. The apparatus 1 is operable to enable a user to select an option of the menu by touching the touch sensitive display 11, in the position 41 in which an icon 65 indicative is presented, with their finger 61 and then rotate their finger 61 on the surface of the touch sensitive display 11 in a clockwise direction as indicated by the arrow 63 so that the actuated area changes orientation.

When the processor 3 detects that a finger 61 is touching the touch sensitive display 11 in a position 41 corresponding to a presented menu option and the orientation of the finger has changed then the processor 3 will select the menu option.

In some embodiments, in order to select a menu option the user may have to rotate their finger by a predetermined amount, for example 90 degrees.

The use of a user input comprising rotating a finger positioned in a particular position on a touch sensitive display to select an option from the menu rather than a user input comprising, for example, a multiple actuation or just a finger being held in the same position for a predetermined time provides the advantage that a user input comprising a rotation of the finger is less likely to be made inadvertently. This therefore reduces the likelihood of menu options being selected unintentionally.

FIG. 5 illustrates a second example of a graphical user interface which is presented on a touch sensitive input device 11 such as a touch sensitive display according to an embodiment of the invention.

The graphical user interface comprises an icon 71 which is presented in a first position 41. The icon 71 represents a dial and comprises a circle 73 having gradings 75 around the circumference of the circle 73. The icon 71 may be associated with a variable parameter of the apparatus 1 so that a user can use the area of the touch sensitive input device 11 where the icon 71 is presented to change the value of the variable parameter.

For example a user may be able to increase the value of a parameter by touching the touch sensitive display 11 with a user input device in the area where the icon is presented and then rotating their finger in a clockwise direction. Similarly the user may be able to decrease a value by rotating their finger counter-clockwise.

The amount by which the variable parameter is changed may depend on the number of degrees through which the user rotates the user input device and thereby rotates the actuated area. The gradings 75 may indicate values of the variable parameter.

The variable parameter may be, for example, the volume of the apparatus 1 or the brightness of the backlighting of the touch sensitive display 11.

The use of an icon 71 and a rotating input to change a variable parameter is intuitive to a user as dials which can be physically twisted to change a variable parameter are well known.

Furthermore the use of a circular dial as illustrated in FIG. 5 provides a compact way of presenting the range of variation available and may be particularly beneficial in apparatus with restricted display areas.

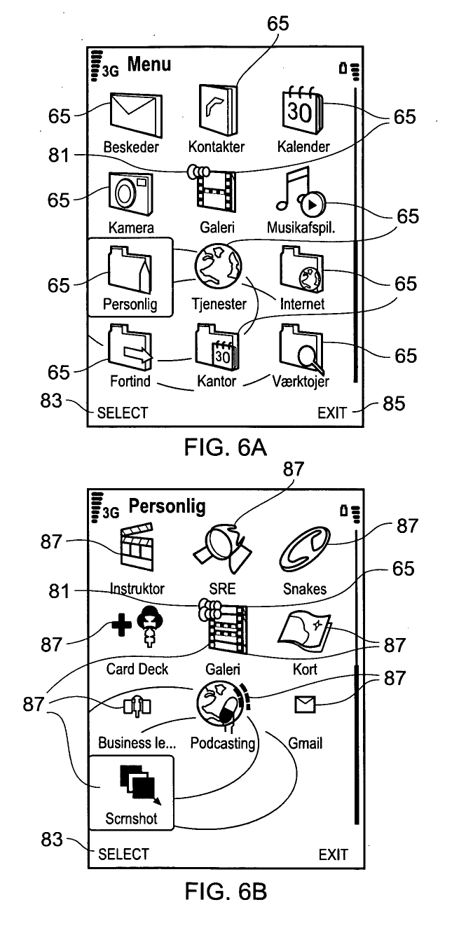

FIG. 6A illustrates a user interface according to another embodiment of the invention. The user interface may be presented on a display such as a touch sensitive display.

The user interface comprises a plurality of menu options which are presented as icons 65 on a display. The “Galleri” icon has been fixed into place by making a rotation user input. That is, a user has contacted a touch sensitive input device 11 with a user input device in the region corresponding to the “Galleri” icon and has rotated the user input device so that the area actuated by the user input device has changed orientation. In response to the detection of the change in orientation the “Galleri” icon has been fixed into position. The processor 3 controls the display to present another icon 81 adjacent the “Galleri” icon indicating that the “Galleri” icon has been fixed into position.

The graphical user interface also comprises a select icon 83 which enables a user to select a highlighted menu option and an exit icon 85 which enables a user to exit the menu.

In FIG. 6A the user has highlighted the “Personalig” option from the menu. The “Personalig” option may be highlighted by touching the touch sensitive input device 11 in a region corresponding to the “Personalig” icon. Once the option is highlighted the user can then select the “Personalig” option by actuating the select icon 83. The select icon 83 may be actuated by touching the touch sensitive input device 11 in a region corresponding to the select icon 83.

In response to the section of the “Personalig” option the processor 3 will control the display to present a list of further menu options associated with the “Personalig” option. The options are presented as a further list of user selectable icons 87 as illustrated in FIG. 6B. The list of menu options also includes the “Galleri” option because this has been fixed into place in the menu so that even when a user has navigated to a different level of the menu the “Galleri” option is still available for selection.

The blocks illustrated in the FIG. 2 may represent steps in a method and/or sections of code in the computer program 7. The illustration of a particular order to the blocks does not necessarily imply that there is a required or preferred order for the blocks and the order and arrangement of the blocks may be varied.

Although embodiments of the present invention have been described in the preceding paragraphs with reference to various examples, it should be appreciated that modifications to the examples given can be made without departing from the scope of the invention as claimed. For example in the above described embodiments the user input device remains in substantially the same position while the orientation of the user input device is changed. In other embodiments the user may move the user input device across the surface of the touch sensitive input device 11 while they are changing the orientation of the user input device so that the input is a combination of a trace input and the rotation of the user input device.

Features described in the preceding description may be used in combinations other than the combinations explicitly described.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

I/we claim:

1. An apparatus comprising:
a touch sensitive input device configured to provide an output dependent upon an actuated area; and
a processor configured to receive inputs from the touch sensitive input device; wherein the processor is configured to detect a change in orientation of an actuated area and, in response to the detection of the change in orientation, perform a function.

2. An apparatus as claimed in claim 1 wherein the touch sensitive input device has sensitivity configured to differentiate between an actuated area in a first orientation and an actuated area in a second orientation.

3. An apparatus as claimed in claim 1 wherein an actuated area is an area of contiguous sensors of the touch sensitive input device which are contemporaneously actuated by a user.

4. An apparatus as claimed in claim 3 wherein the sensors are actuated by a user input device which is brought into contact with the touch sensitive input device.

5. An apparatus as claimed in claim 4 wherein the user input device remains in contact with the touch sensitive input device during the change in orientation.

6. An apparatus as claimed in claim 1 wherein the processor is configured to determine the direction of the change of orientation and the function performed depends on the direction of the change of orientation.

7. An apparatus as claimed in claim 1 wherein the processor is configured to determine the magnitude of the change in orientation and the function performed depends on the magnitude of the change in orientation.

8. An apparatus as claimed in claim 1 wherein the apparatus has a plurality of modes of operation and the function performed in response to the detection of the change in orientation depends on the mode of operation of the apparatus.

9. An apparatus as claimed in claim 1 wherein the function performed depends upon the region of the touch sensitive input device in which the actuated area is located.

10. A method comprising;
receiving a first input from a touch sensitive input device when an area of the touch sensitive input device in a first orientation is actuated;
receiving a second input from the touch sensitive input device when an area of the touch sensitive input device in a second orientation is actuated;
detecting, using the first input and the second input, change in the orientation; and
performing, in response to the detection of the change in orientation, a function.

11. A method as claimed in claim 10 wherein an area of the touch sensitive input device is actuated when an area of contiguous sensors of the touch sensitive input device are contemporaneously actuated by a user.

12. A method as claimed in claim 11 wherein the sensors are actuated by a user input device which is brought into contact with the touch sensitive input device.

13. A method as claimed in claim 12 wherein the user input device remains in contact with the touch sensitive input device during the change in orientation.

14. A method as claimed in claim 10 further comprising determining the direction of the change of orientation wherein the function performed depends on the direction of the change of orientation.

15. A method as claimed in claim 10 further comprising determining the magnitude of the change in orientation wherein the function performed depends on the magnitude of the change in orientation.

16. A method as claimed in claim 10 further comprising determining a mode of operation of an apparatus wherein the function performed in response to the detection of the change in orientation depends on the mode of operation of the apparatus.

17. A method as claimed in claim 10 further comprising determining the region of the touch sensitive display in which the area which has been actuated is located wherein the function performed depends upon the region of the touch sensitive input device in which the area which has been actuated is located.

18. A computer program comprising program instructions for controlling an apparatus, the apparatus comprising, a touch sensitive input device, the program instructions providing, when loaded into a processor:
means for receiving a first input from the touch sensitive input device when an area of the touch sensitive input device in a first orientation is actuated;
means for receiving a second input from the touch sensitive input device when an area of the touch sensitive input device in a second orientation is actuated;
means for detecting, using the first input and the second input, change in the orientation; and
means for performing, in response to the detection of change in the orientation, a function.

19. A physical entity embodying the computer program as claimed in claim 18.

20. An electromagnetic carrier signal carrying the computer program as claimed in claim 18.

21. A computer program comprising program instructions for causing a computer to perform the method of claim 10.

22. A user interface comprising:
a touch sensitive input device configured to provide an output dependent upon an actuated area such that the outputs provided by the touch sensitive input device enable a processor to detect change in orientation of an actuated area: and
wherein in response to the detection of the change in orientation, a function is performed.

23. A user interface as claimed in claim 22 wherein the touch sensitive input device has sensitivity configured to differentiate between an actuated area in a first orientation and an actuated area in a second orientation.

24. A user interface as claimed in claim 22 wherein an actuated area is an area of contiguous sensors of the touch sensitive input device which are contemporaneously actuated by a user.

25. A user interface as claimed in claim 24 wherein the sensors are actuated by a user input device which is brought into contact with the touch sensitive input device.
